(19) United States
(12) Patent Application Publication
(10) Pub. No.: US 2024/0419857 A1
(43) Pub. Date: Dec. 19, 2024

(54) TECHNOLOGIES FOR USING RESULTS OF PHYSICAL AND VIRTUAL PRODUCT TESTS TO ASSESS PRODUCT STANDARDS COMPLIANCE

(71) Applicant: UL LLC, Northbrook, IL (US)

(72) Inventor: Dirk Mueller, Bad Soden A/TS. (DE)

(21) Appl. No.: 18/209,994

(22) Filed: Jun. 14, 2023

(51) Int. Cl. G06F 30/20; G01R 31/12

(52) U.S. Cl. CPC G06F 30/20; G01R 31/1227; G06F 2119/02

(57) ABSTRACT

Systems and methods for employing physical and virtual testing of products to assess compliance with standards are provided. According to certain aspects, a physical testing machine may perform a physical test of a physical product. Additionally, an electronic device may perform multiple virtual tests of multiple virtual versions of the physical product based on an output of the physical test as well as an applicable standard. Based on the results of the virtual tests, the electronic device may determine whether to certify a physical version of one of the virtual versions of the physical product according to the applicable standard.

### FIELD

The present disclosure is directed to assessing physical product performance. More particularly, the present disclosure is directed to platforms and technologies for using results of physical and virtual testing to determine whether certain physical products should be certified according to product standards.

### BACKGROUND

A product standard is a set of guidelines, requirements, or specifications established by recognized standardization bodies. These standards provide detailed descriptions of what a product of a certain type should be, how it should function, its dimensions, performance criteria, safety considerations, and/or its manufacturing process. Product standards are typically developed to ensure product safety, interoperability, and consistency. Certifying products according to product standards is important for several reasons, including for ensuring safety, quality, and interoperability, as well instilling consumer confidence, creating market access, and assessing environmental impact.

Products are often tested using physical machines to assess whether the products should be certified according to an applicable set of standards. While some virtual tests (i.e., simulation or computational testing) have experienced increasing usage, there are certain products where a physical test will result in an output parameter or determination which is difficult or impossible to replicate using a virtual test. Accordingly, in these situations, virtual tests are not helpful to use or cannot be used to assess how a corresponding physical version of the product would perform.

Accordingly, there is an opportunity to employ various techniques and technologies to correlate physical tests with virtual tests to assess the performance of physical products with respect to a product standard.

### SUMMARY

In an embodiment, a computer-implemented method of assessing product compliance is provided. The computer-implemented method may include: performing, by a testing machine, a physical test of a physical product having a first set of parameters, wherein the physical test results in an output value of a first metric corresponding to a test failure of the physical product; facilitating, by at least one computer processor, a first virtual test of a first virtual version of the physical product having the first set of parameters, wherein the first virtual test employs the output value of the first metric and results in an output value of a second metric different from the first metric; facilitating, by the at least one computer processor, a second virtual test of a second virtual version of the physical product having a second set of parameters, wherein the second virtual test employs a test value of the first metric and results in an additional output value of the second metric; and comparing, by the at least one computer processor, the output value of the second metric to the additional output value of the second metric to determine whether the physical product having the second set of parameters would be certified according to a standard.

In another embodiment, a system for assessing product compliance is provided. The system may include: a testing machine configured to perform a physical test of a physical product having a first set of parameters, wherein the physical test results in an output value of a first metric corresponding to a test failure of the physical product; a memory storing computer-executable instructions; and at least one processor interfaced with the memory and configured to execute the computer-executable instructions to cause the at least one processor to: facilitate a first virtual test of a first virtual version of the physical product having the first set of parameters, wherein the first virtual test employs a test value of the first metric and results in an output value of a second metric different from the first metric, facilitate a second virtual test of a second virtual version of the physical product having a second set of parameters, wherein the second virtual test employs the output value of the first metric and results in an additional output value of the second metric, and compare the output value of the second metric to the additional output value of the second metric to determine whether the physical product having the second set of parameters would be certified according to a standard.

Further, in an embodiment, a non-transitory computer-readable storage medium configured to store instructions executable by one or more processors is provided. The instructions may include: instructions for accessing an output value of a first metric resulting from a physical test of a physical product having a first set of parameters, wherein the physical test is performed by a testing machine, and wherein the output value of the first metric corresponds to a test failure of the physical product during the physical test; instructions for facilitating a first virtual test of a first virtual version of the physical product having the first set of parameters, wherein the first virtual test employs the output value of the first metric and results in an output value of a second metric different from the first metric; instructions for facilitating a second virtual test of a second virtual version of the physical product having a second set of parameters, wherein the second virtual test employs a test value of the first metric and results in an additional output value of the second metric; and instructions for comparing the output value of the second metric to the additional output value of the second metric to determine whether the physical product having the second set of parameters would be certified according to a standard.

### BRIEF DESCRIPTION OF THE FIGURES

FIG. 1 depicts an overview of components and entities associated with the systems and methods, in accordance with some embodiments.

FIG. 2 depicts an example signal diagram including certain functionalities associated with the systems and methods, in accordance with some embodiments.

FIG. 3 is an example flowchart associated with assessing product compliance, in accordance with some embodiments.

FIG. 4 is a hardware diagram of an example server, in accordance with some embodiments.

### DETAILED DESCRIPTION

The present embodiments may relate to, inter alia, platforms and technologies for reconciling the outputs of physical and virtual tests for certain products, such as to assess compliance of the products with standards. According to certain aspects, a physical testing machine may perform a physical test on a physical product, where the physical test is designed to cause a test failure or fault condition of the physical product. The point at which the physical product experiences the test failure or fault condition is recorded and outputted.

A virtual test using a “digital twin” or virtual version of the physical product may be conducted, where the virtual test may employ the output value of the physical test that caused the test failure or fault condition of the physical product. The virtual test may result in an output value that differs from the output value of the physical test in that the output value of the virtual test may be of a metric that differs from that of the output value of the physical test. An additional virtual test may be conducted on an additional virtual version of the physical product, where the additional virtual version may have parameters that differ from those of the virtual version. The additional virtual test may employ a test input that is specified by a given product standard, which results in an additional output value of a metric that is the same as the metric of the initial virtual test. The output value of the initial virtual test may be compared to the additional output value to assess whether a physical version having the parameters of the additional virtual version would be certified according to the product standard.

The described systems and methods represent an improvement over existing technologies, including physical testing of products to assess compliance with standards, for many reasons. In particular, the systems and methods at least partially employ virtual testing using digital twins or virtual versions of physical products. Physical tests are expensive due to material costs, labor costs, equipment costs, and setup costs. In contrast, virtual testing can often be performed at a fraction of the cost, especially in the development phase. Further, virtual tests can be facilitated much more efficiently than physical tests. While physical tests often require the production of prototypes and can take days or weeks to set up and execute, a virtual test can be run immediately and results can be obtained in a short period. Similarly, once a virtual model has been created, it can be used an infinite number of times, and the same test can be run under a variety of different conditions, which allows for thorough and repeatable testing, which may not be feasible with physical prototypes.

Additionally, in industries where the testing process can be dangerous (e.g., aerospace, automotive, or nuclear energy), virtual testing eliminates the risks associated with physical tests. Virtual tests also provide for predictive capability because the virtual test can simulate and predict potential failures or wear and tear over time, allowing designers to preemptively address these issues. Further, virtual testing allows for testing before any physical prototype is built, hence allowing for early detection of design flaws and reducing the number of iterations needed in the product development cycle. Moreover, virtual testing allows for the simulation of complex phenomena or situations that are difficult to recreate in a physical testing environment.

In some situations, it is impossible for virtual tests to simulate certain aspects of a corresponding physical test. For example, there is no known way to simulate the electrical breakdown of a real-life, physical product. This is because electrical breakdown often involves intricate physical processes at the atomic or molecular level (e.g., in the case of a dielectric breakdown, the behavior and interactions of electrons, ions, and neutral particles can become extremely complex and chaotic). Further, the specific properties of the materials involved, such as conductivity, permittivity, dielectric strength, and their variations with temperature, pressure, and other environmental factors, can all affect the electrical breakdown process, where simulating these accurately requires detailed knowledge and data about these properties. Additionally, electrical breakdown can also be affected by various environmental conditions (e.g., temperature, pressure, humidity, dust, vibration, etc.), which have complex and nonlinear effects on the breakdown process, making it challenging to accurately incorporate them into a simulation.

Indeed, some virtual tests result in an output that has a different metric or variable than an output of a corresponding physical test. For example, a physical test of a physical cable can determine the voltage at which the physical cable experiences a breakdown event; however a corresponding virtual test of a virtual cable will result in an array of electric field strengths, which is different than the breakdown voltage resulting from the physical test. Accordingly, the virtual test, in and of itself, is useless in assessing whether the virtual cable would pass the corresponding physical test, let alone determining whether a physical version of the virtual cable should be certified according to a standard.

The systems and methods improve on these existing virtual testing technologies because the systems and methods incorporate an initial physical test of a physical product, the output of which is used to facilitate an initial virtual test of an initial virtual product that results in a first output having a variable that differs from the variable of the initial physical test. The physical test output is correlated with the first output of the initial virtual test, and the systems and methods facilitate a subsequent virtual test of another virtual product using a test input that corresponds to a given product standard. The systems and methods compare an output of the subsequent virtual test to the first output of the initial virtual test (which have aligning variables) to determine whether a physical version of the another virtual product should be certified according to the given product standard. Thus, the systems and methods effectively and efficiently reconcile for differences between the outputs of physical and virtual tests.

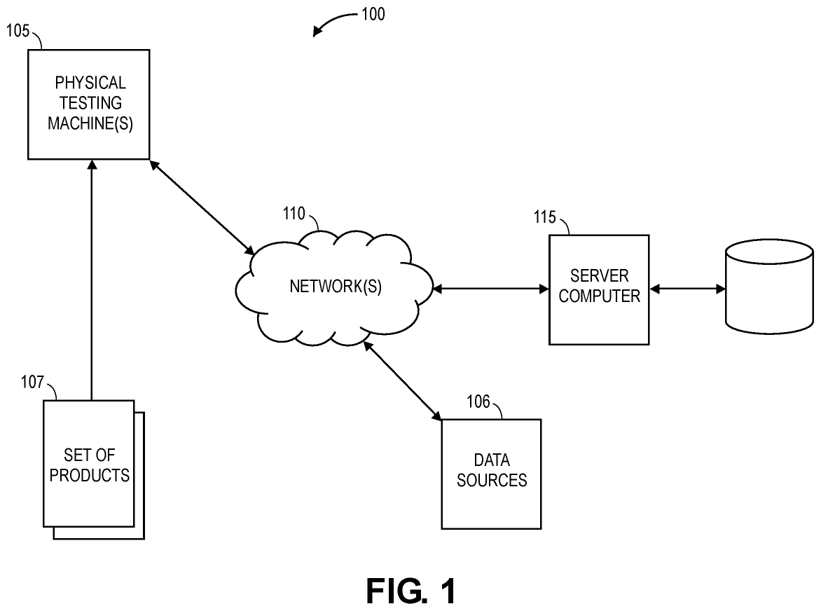

FIG. 1 illustrates an overview of a system 100 of components configured to facilitate the systems and methods. It should be appreciated that the system 100 is merely an example and that alternative or additional components are envisioned.

As illustrated in FIG. 1, the system 100 may include a set of physical testing machines 105. Generally, each physical testing machine 105 is a physical machine that may be configured to test one or more of a set of products 107, such as to assess performance of the set of products 107. In embodiments, a specific testing machine 105 may be configured to test a specific product 107 to assess compliance with a specific standard.

For example, the physical testing machine(s) 105 may be an AC dielectric test set, a tensile testing machine, a compression testing machine, a hardness testing machine, a flammability testing machine, an environmental testing chamber, a spectrophotometer, an electromagnetic compatibility (EMC) test equipment, an ingress protection (IP) testing equipment, a vibration testing machine, a salt spray chamber, and/or another testing machine. Further, for example, the set of products 107 may be electronics and electrical components, aerospace and defense equipment, automotive components, pharmaceuticals and medical devices, building materials, packaging materials, solar panels and renewable energy equipment, and/or other products. Additionally, for example, the one or more standards may be set by standard-setting organizations (SSO) such as the International Organization for Standardization (ISO), National Fire Protection Association (NFPA), American National Standards Institute (ANSI), Underwriters Laboratories (UL), Institute of Electrical and Electronics Engineers (IEEE), International Electrotechnical Commission (IEC), European Committee for Standardization (CEN), and/or others.

The physical testing machine(s) 105 may be configured to communicate with a server computer 115 via one or more networks 110. According to embodiments, the physical testing machine(s) 105 may be configured to provide results of any physical tests that it conducts or facilitates to the server computer 115. The network(s) 110 may support any type of data communication via any standard or technology (e.g., GSM, CDMA, VOIP, TDMA, WCDMA, LTE, EDGE, OFDM, GPRS, EV-DO, UWB, Internet, IEEE 802 including Ethernet, WiMAX, Wi-Fi, Bluetooth, and others). The server computer 115 may be associated with an entity such as a company, business, SSO, corporation, or the like, which designs, markets, manufactures, tests, and/or sells products, or is otherwise involved in the supply chains of the products. The server computer 115 may include various components that support communication with the physical testing machine(s) 105.

The server computer 115 may communicate with one or more data sources 106 via the network(s) 110. In embodiments, the data source(s) 106 may compile, store, or otherwise access information associated with product tests, standards, certifications, requirements, and/or the like. In particular, the data source(s) 106 may represent SSOs, certification entities, governing bodies, and/or the like, and may provide data, to the server computer 115, indicative of or representing various product tests, standards, certifications, or the like. For example, one of the data sources 106 may represent the NFPA, and may provide, to the server computer 115, data associated with NFPA 262 or other NFPA standards.

According to embodiments, the server computer 115 may be configured to perform or facilitate a series of virtual tests on a series of virtual versions of the set of products 107 that the physical testing machine(s) 105 test. The virtual versions of the set of products 107 may be “digital twins” of the set of products 107, or the virtual versions may have different characteristics or parameters as those of the set of products 107. For example, the product 107 may be a cable having given conductor and insulation materials, size, number of conductors, jacket material, and the like, where the virtual version of the product 107 may be a digital twin of the product 107 (i.e., having parameters that match those of the product 107), or may have different conductor and insulation materials, size, number of conductors, jacket material, etc.

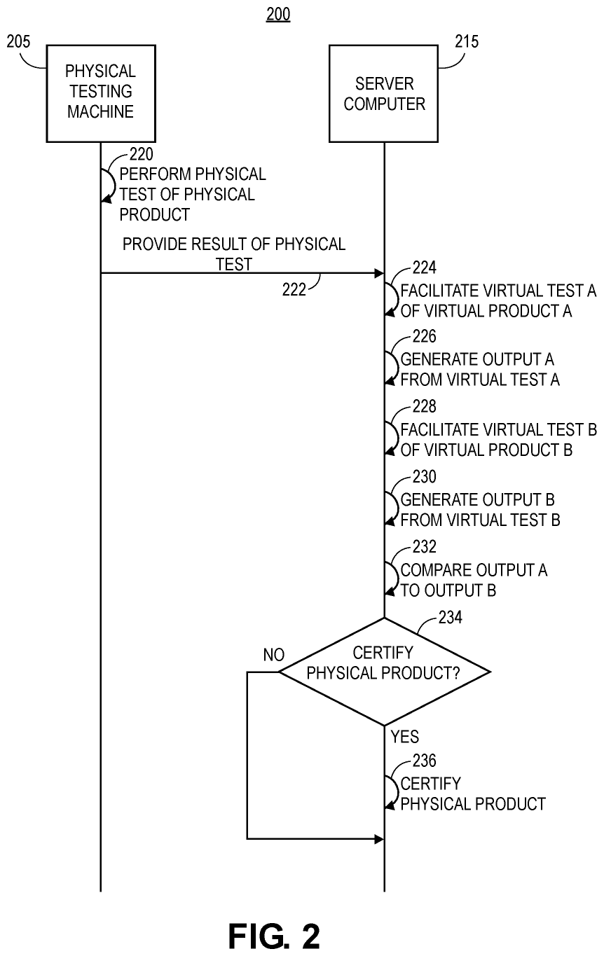

Based on the results of the physical test performed by the physical testing machine(s) 105 and the virtual tests facilitated by the server computer 115, the server computer 115 may assess compliance with a specific standard, such as a specific standard that the server computer 115 receives or accesses from the data sources 106. In particular, the server computer 115 may assess whether a physical version of a virtual product that has been tested using a virtual test should be certified according to the specific standard. In embodiments, the server computer 115 may facilitate certifying the physical version of the virtual product according to the specific standard, or may interface with another entity (not shown in FIG. 1) to cause the physical version of the virtual product to be certified according to the specific standard. Additional details regarding these functionalities are described with respect to FIG. 2.

The server computer 115 may be configured to interface with or support a memory or storage 113 capable of storing various data, such as in one or more databases or other forms of storage. According to embodiments, the storage 113 may store data or information associated with any of the physical and virtual tests that are performed or facilitated, including the results thereof, any standards for which compliance is being assessed, and/or other data.

Although depicted as a single server computer 115 in FIG. 1, it should be appreciated that the server computer 115 may be in the form of a distributed cluster of computers, servers, machines, or the like. In this implementation, the entity may utilize the distributed server computer(s) 115 as part of an on-demand cloud computing platform. Accordingly, when the physical testing machine(s) 105 interfaces with the server computer 115, the physical testing machine(s) 105 may actually interface with one or more of a number of distributed computers, servers, machines, or the like, to facilitate the described functionalities.

FIG. 2 illustrates an example signal diagram 200 with functionalities according to the described embodiments. The signal diagram 200 may include a physical testing machine 205 (such as the physical testing machine(s) 105 as described with respect to FIG. 1) and a server computer 215 (such as the server computer 115 as described with respect to FIG. 1). It should be appreciated that the signal diagram 200 may include additional elements, such as one or more data sources from which the server computer 215 may retrieve information related to product standards and/or tests.

The signal diagram 200 may begin at 220 where the physical testing machine 205 performs a physical test of a physical product. Generally, the physical test may be conducted to determine a limit or test failure point for the physical product, and may be performed to assess compliance with industry standards, or for quality control, safety certification, or research and development purposes. It should be appreciated that a combination of one or more components may form the physical product. Additionally, the physical product may be one or more of electronics and electrical components, aerospace and defense equipment, automotive components, pharmaceuticals and medical devices, building materials, packaging materials, solar panels and renewable energy equipment, and/or other product(s).

The physical product may have a set of parameters that may generally be descriptive of one or more characteristics or qualities of the physical product. For example, if the physical product is a cable, the set of parameters may be length, diameter, composition or material, number and size of conductors, impedance, attenuation, capacitance and inductance, shielding, bandwidth of frequency range, maximum voltage or current, bend radius, temperature range, and/or others. It should be appreciated that different physical products may have different or overlapping parameters.

In embodiments, the physical test may be configured to operate until a test failure event or condition associated with the physical product occurs. For example, the physical test may be a dielectric test that is performed on the physical product to determine its ability to withstand a specified voltage at a certain frequency for a given period of time. This test is often conducted on electrical insulation systems, including those found in transformers, switchgear, cables, and other high-voltage equipment, and its purpose is to ensure that the system can reliably withstand the operational voltage under both normal and potentially stressful conditions, without experiencing dielectric breakdown. During this test, an AC voltage of a specified frequency is applied to the product under test. This voltage is gradually increased to a test value, which is usually higher than the physical product's normal operating voltage. If the product withstands the voltage for a specified period of time (usually a minute or a few minutes) without showing signs of electrical breakdown, it is considered to have passed the test. According to embodiments, the breakdown voltage may be the voltage applied to the physical product which causes the electrical breakdown of the product, where the value of this breakdown voltage may be recorded.

It should be appreciated that additional physical tests are contemplated for testing test failure conditions including, for example, a dielectric withstand test, an impulse voltage test, a partial discharge test, a thermal cycle test, a vibration test, an ingress protection (IP) test, a salt spray test, and an electrostatic discharge (ESD) test, among others. According to embodiments, each physical test may be configured to output a value of a metric corresponding to a test failure of the physical product. For example, if the test is a power frequency test, the output is a voltage at which the physical product experiences electrical breakdown (e.g., 2500V). For further example, if the test is a thermal cycle test, the output is a temperature at which the physical product experiences failure (e.g., 120° C.).

The physical testing machine 205 may provide (222) a result of the physical test to the server computer 215. In embodiments, the result may be the value of the metric corresponding to the test failure of the physical product. For example, the result may be the voltage at which the physical product experiences electrical breakdown, the temperature at which the physical product experiences failure, or another value of another metric.

The server computer 215 may facilitate (224) a virtual test A of virtual product A. According to embodiments, the virtual product A may be a digital twin of the physical product. Generally, a digital twin is a virtual representation of the physical product, and may be created (e.g., by the server computer 215) using real-time data, machine learning or artificial intelligence (AI) techniques, and/or software analytics to be a digital mirror of the digital product, which enables for the simulation, prediction, and optimization of the operation of a system or product without having to interact with the actual physical product. Thus, a digital twin of a physical product may be a detailed digital model that represents not only the physical characteristics of the physical product but also its behavior under various conditions; accordingly, the virtual product A may have the same set of parameters as the physical product, where the set of parameters may generally be descriptive of one or more qualities or characteristics of the virtual product A.

Generally, the virtual test A may involve a wide range of simulation techniques depending on the type of product, its intended use, and the specific standards that may be of interest to assess compliance. Further, the virtual test A may involve analyzing the virtual product A using specialized software to simulate how the corresponding physical product would respond. For example, a virtual test may be performed on an virtual electronic component to test compliance with various types of standards, including electromagnetic compatibility (EMC) standards, thermal performance standards, and/or the like. Further, for example, a virtual test may be a thermal simulation that may be used to ensure that the virtual electronic component will not overheat under normal operating conditions.

In facilitating the virtual test A, the server computer 215 may employ the output value of the physical test. For example, if the physical test is a dielectric test having a result or output value of 2500V (i.e., the voltage at which the physical product experiences electrical breakdown), the server computer 215 may facilitate the virtual test A by virtually applying a voltage of 2500V.

The server computer 215 may generate (226) an output A resulting from the virtual test A. According to embodiments, the output A may be in one or more different forms depending on the specific virtual test performed and the software used. For example, the output A may be numerical data that can be processed and analyzed (e.g., a virtual stress test on a virtual bridge might output the maximum stress experienced by each part of the virtual bridge under a given load); a visual representations that may be examined (e.g., a color-coded heatmap showing areas of high stress or high temperature, 3D models demonstrating deformations or structural changes under certain conditions, or graphical representations of various factors over time, like speed, temperature, or pressure); graphs and/or charts that may show how certain variables change over time or under different conditions (e.g., a graph might show how the temperature of a component in an electronic device increases over time); reports that may summarize the results of a virtual test, and that may include pass/fail indicators for certain standards, comparisons against benchmark data, and more; and animations that may show how the tested product responds over time (e.g., a crash test simulation for a car might show an animation of the impact and how different parts of the car deform as a result).

In embodiments in which the virtual test A performed on the virtual product A is a dielectric test, the output may be an electric field strength or an array of electric field strengths, where the array of electric field strengths may be a collection of values representing the intensity of the electric field at various points within or around the virtual product A. The array may be presented in various formats, such as a 3D map, a table or array of values, or a color-coded heat map overlaid on a model of the virtual product A, where each point or cell in the array may represent the electric field strength at a specific location.

The server computer 215 may correlate the result of the physical test of the physical product with the output A from the virtual test A. For example, if the physical test is a dielectric test with an output of a breakdown voltage and the virtual test A is a virtual dielectric test with an output of an electric field strength, the breakdown voltage is correlated with the electric field strength.

Generally, to correlate the result of the physical test and the output A from the virtual test A, the server computer 215 may calculate a correlation coefficient, which may a measure of how closely the two variables are related, using methods such as Pearson's correlation if the relationship is linear, or Spearman's rank correlation if the relationship is not linear but still monotonic. In some situations, the server computer 215 may build a regression model using the result from the physical test as the independent variable and the output A from the virtual test A as the dependent variable, where the regression model may be a simple linear regression if the relationship is linear, or a more complex model like a polynomial regression or a machine learning model if the relationship is non-linear.

The server computer 215 may also facilitate (228) a virtual test B of a virtual product B. In embodiments, the virtual product B may also be a virtual version of the physical product, however the virtual product B may have a set of parameters that are different from that of the physical product and from that of the virtual product A. The set of parameters for the virtual product B may generally be descriptive of one or more qualities or characteristics of the virtual product B. According to embodiments, the virtual test B of the virtual product B may be the same type of test as the virtual test A that was performed on the virtual product A. For example, the virtual test B may be a virtual dielectric test.

In facilitating the virtual test B, the server computer 215 may employ a value that is associated with a specific standard related to a physical version of the virtual product B. For example, the virtual product B may be a virtual medical electrical equipment that, in physical form, is subject to International Electrotechnical Commission (IEC) standard 60601-1, which specifies that the medical electrical equipment must withstand a voltage level of 1500V in order to be certified according to the standard. In this example, the value employed in facilitating the virtual test B may be 1500V. As used herein, this value that is employed in facilitating the virtual test B may be referred to as a test value.

The server computer 215 may generate (230) an output B resulting from the virtual test B, where the output B may be in one or more different forms depending on the specific virtual test performed and the software used, as similarly discussed herein with respect to the virtual test A. For example, if the virtual test B performed on the virtual product B is a dielectric test, the output may be an electric field strength or an array of electric field strengths, where the array of electric field strengths may be a collection of values representing the intensity of the electric field at various points within or around the virtual product B.

The server computer 215 may compare (232) the output A to the output B, where the output A and the output B may be of the same variable. In embodiments, the server computer 215 may perform the comparison to determine whether output B meets or exceeds output A. Because the output A is correlated to the result of the physical test that caused failure of the physical product, the output A represents the value at which the virtual product A should “fail.” Therefore, if the output B is equal to or greater than the output A, the server computer 215 may determine that the physical version of the virtual product B will fail; conversely, if the output B is less than the output A, the server computer 215 may determine that the physical version of the virtual product B will not fail.

Based on the comparison of (232), the server computer 215 may determine (234) whether to certify the physical version of the virtual product B. In particular, if the output B is equal to or greater than the output A, the server computer 215 may determine that the physical version of the virtual product B should not be certified (“NO”), at which point the signal diagram 200 may end, repeat, or proceed to different functionality. In contrast, if the output B is less than the output A, the server computer 215 may determine that the physical version of the virtual product B should be certified (“YES”), at which point the signal diagram may proceed to (236).

At (236), the server computer 215 may certify the physical version of the virtual product B. In embodiments, the server computer 215 may interface with an SSO (e.g., an SSO associated with the standard that was tested in accordance with the virtual test B) and provide the result of the determination of (234), where the SSO may facilitate certification of the physical version of the virtual product B.

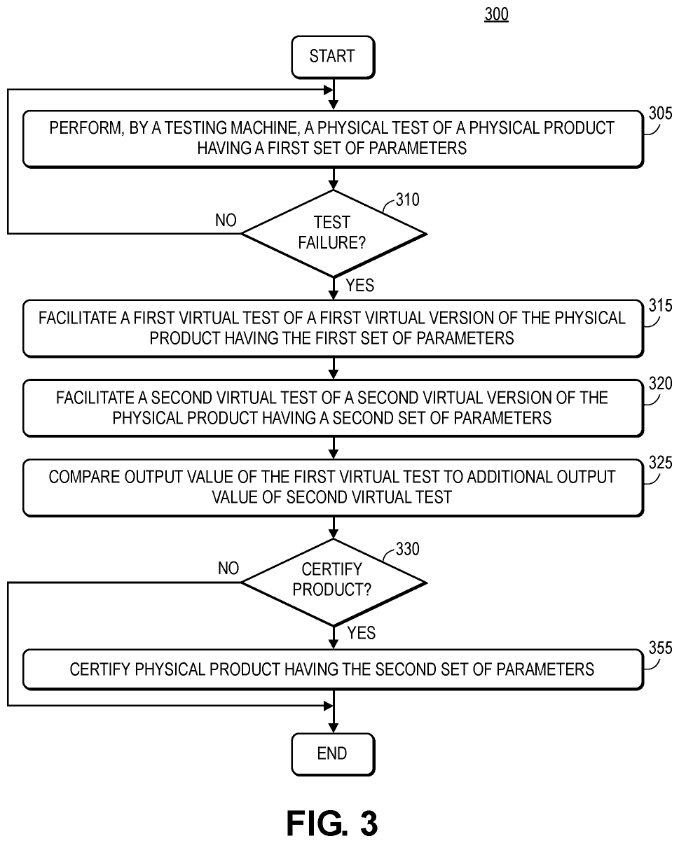

FIG. 3 depicts is a block diagram of an example method 300 of assessing product compliance. The method 300 may be facilitated by a testing machine (such as the physical testing machine 105 as discussed with respect to FIG. 1) as well as an electronic device (such as the server computer 115 as discussed with respect to FIG. 1) that may be in communication with additional devices or data sources.

The method 300 may begin when the testing machine performs (block 305) a physical test of a physical product having a first set of parameters. In embodiments, the physical test may be a dielectric test that is performed (e.g., by an AC dielectric test set) on a test sample having the first set of parameters. Generally, in performing the physical test, the testing machine may apply a specified input on the physical product. For example, the AC dielectric test set may apply a set voltage to the test sample.

The testing machine may determine (block 310) whether the physical product experiences a test failure. For example, a test sample may experience dielectric breakdown when a certain voltage input is applied to the test sample in the course of the dielectric test. If the physical product does not experience a test failure (“NO”), processing may return to block 305 in which the testing machine may modify the test input that is applied to the physical product, and again perform the physical test according to the modified test input. For example, if the test sample does not experience dielectric breakdown, the testing machine may increase the set voltage that is applied to the test sample. Blocks 305 and 310 may be repeated until the physical product experiences a test failure.

If the physical product does experience a test failure (“YES”), processing may proceed to block 310. Additionally, the testing machine and the electronic device may record, as an output value of a first metric, the value of the test input that was applied to the physical product that caused the test failure. For example, if the physical test is the dielectric test and the test input that caused the dielectric breakdown of the test sample is 2500V, then the output value is 2500 and the first metric is volts (V).

At block 310, the electronic device may facilitate a first virtual test of a first virtual version of the physical product having the first set of parameters. In facilitating the first virtual test, the electronic device may employ the output value of the first metric (i.e., that caused the test failure). Further, the first virtual test may result in an output value of a second metric different from the first metric. For example, if the output value of the first metric is 2500V, the output value of the first virtual test may be an array of local electric field strengths (e.g., in a range up to 20 kV/mm).

At block 315, the electronic device may facilitate a second virtual test of a second virtual version of the physical product having a second set of parameters. In facilitating the second virtual test, the electronic device may employ a test value of the first metric, where the test value may be specified by a standard test associated with the physical product. For example, a given standard (e.g., UL 83 (Underwriters Laboratories' standard for Thermoplastic-Insulated Wires and Cables)) may specify a test value of 2000V, meaning that tested cables must withstand a voltage of 2000V without breakdown during a test in order to be certified to this standard. The second virtual test may result in an additional output value of the second metric. For example, the additional output value of the second metric may be an additional array of local electric field strengths in kV/mm.

At block 320, the electronic device may compare the output value of the first virtual test to the additional output value of the second virtual test. This comparison is made possible by virtue of the output value of the first virtual test being of the same metric as that of additional output value of the second virtual test, which improves upon existing technologies in which the output metric of a physical test does not match that of a virtual test.

Based on the comparison of block 320, the electronic device may determine (block 325) whether the physical product having the second set of parameters (i.e., a physical version of the second virtual version) would be certified according to a standard. In embodiments, the standard may align with the standard that is associated with the test value that is employed in the second virtual test.

In embodiments, if the electronic device determines that the additional output value of the second metric is equal to or greater than the output value of the second metric, the electronic device may determine that the physical product having the second set of parameters should not be certified according to the standard (“NO”). In this situation, processing may end, repeat, or proceed to other functionality. Conversely, if the electronic device determines that the additional output value of the second metric is less than the output value of the second metric, the electronic device may determine that the physical product having the second set of parameters should be certified according to the standard (“YES”). In this situation, processing may proceed to block 335 in which the electronic device may certify the physical product having the second set of parameters.

For example, if the array of local electric field strengths resulting from the second virtual test is equal to or greater than the array of local electric field strengths resulting from the first virtual test, the electronic device may determine that the physical product having the second set of parameters should not be certified (and vice-versa). It should be appreciated that the electronic device may facilitate the certification of the physical product in any way, or may otherwise determine that the physical product should be certified.

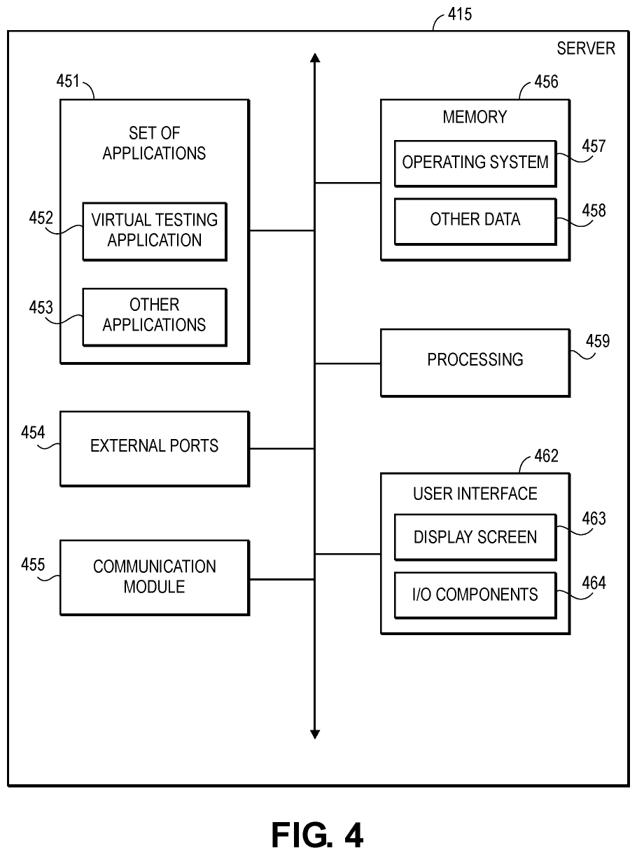

FIG. 4 illustrates a hardware diagram of an example server 415 (e.g., one of the server computers 115, 215 as described with respect to FIGS. 1 and 2), in which the functionalities as discussed herein may be implemented. It should be appreciated that the components of the server 415 are merely exemplary, and that additional or alternative components and arrangements thereof are envisioned. Generally, the server 415 may interface with a physical testing machine as well other components and entities via a network(s), as discussed herein.

As illustrated in FIG. 4, the server 415 may include a processor 459 as well as a memory 456. The memory 456 may store an operating system 457 capable of facilitating the functionalities as discussed herein as well as a set of applications 451 (i.e., machine readable instructions). For example, one of the set of applications 451 may be a virtual testing application 452 that may be configured to facilitate virtual tests of virtual products. It should be appreciated that one or more other applications 453 are envisioned, such as an application configured to assess compliance of physical versions of virtual products with standards.

The processor 459 may interface with the memory 456 to execute the operating system 457 and the set of applications 451. According to some embodiments, the memory 456 may also store other data 458, such as product data, standards data, testing data, and/or other data. The memory 456 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 415 may further include a communication module 455 configured to communicate data via the network(s). According to some embodiments, the communication module 455 may include one or more transceivers (e.g., WAN, WWAN, WLAN, and/or WPAN transceivers) functioning in accordance with IEEE standards, 3GPP standards, or other standards, and configured to receive and transmit data via one or more external ports 454.

The server 415 may further include a user interface 462 configured to present information to a user and/or receive inputs from the user. As shown in FIG. 4, the user interface 462 may include a display screen 463 and I/O components 464 (e.g., ports, capacitive or resistive touch sensitive input panels, keys, buttons, lights, LEDs, external or built in keyboard). According to some embodiments, the user may access the server 415 via the user interface 462 to review information, make selections, and/or perform other functions.

In some embodiments, the server 415 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 459 (e.g., working in connection with the operating system 457) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of assessing product compliance, the computer-implemented method comprising:
performing, by a testing machine, a physical test of a physical product having a first set of parameters, wherein the physical test results in an output value of a first metric corresponding to a test failure of the physical product;
facilitating, by at least one computer processor, a first virtual test of a first virtual version of the physical product having the first set of parameters, wherein the first virtual test employs the output value of the first metric and results in an output value of a second metric different from the first metric;
facilitating, by the at least one computer processor, a second virtual test of a second virtual version of the physical product having a second set of parameters, wherein the second virtual test employs a test value of the first metric and results in an additional output value of the second metric; and
comparing, by the at least one computer processor, the output value of the second metric to the additional output value of the second metric to determine whether the physical product having the second set of parameters would be certified according to a standard.

2. The computer-implemented method of claim 1, wherein performing the physical test of the physical product comprises:
performing, by the testing machine, a dielectric test of a test sample having the first set of parameters, wherein the dielectric test results in a breakdown voltage.

3. The computer-implemented method of claim 2, wherein facilitating the first virtual test of the first virtual version of the physical product comprises:
facilitating, by the at least one computer processor, a first virtual dielectric test of the first virtual version of the test sample, wherein the first virtual dielectric test results an array of electric field strengths for the first virtual version of the test sample.

4. The computer-implemented method of claim 1, wherein performing the physical test of the physical product comprises:
performing, by the testing machine, the physical test of the physical product by increasing a value of the first metric that is applied to the physical product until a test failure event occurs; and
recording, as the output value of the first metric, the value of the first metric that was applied to the physical product that caused the test failure event.

5. The computer-implemented method of claim 1, wherein comparing the output value of the second metric to the additional output value of the second metric comprises:
determining that the additional output value of the second metric is equal to or greater than the output value of the second metric; and
based on determining that the additional output value is equal to or greater than the output value, determining that the physical product having the second set of parameters should not be certified according to the standard.

6. The computer-implemented method of claim 1, wherein comparing the output value of the second metric to the additional output value of the second metric comprises:
determining that the additional output value of the second metric is less than the output value of the second metric; and
based on determining that the additional output value is less than the output value, determining that the physical product having the second set of parameters should be certified according to the standard.

7. The computer-implemented method of claim 1, wherein the test value of the first metric is specified by a standard test associated with the physical product, and wherein the test value of the first metric is less than the output value of the first metric.

8. A system for assessing product compliance, the system comprising:
a testing machine configured to perform a physical test of a physical product having a first set of parameters, wherein the physical test results in an output value of a first metric corresponding to a test failure of the physical product;
a memory storing computer-executable instructions; and
at least one processor interfaced with the memory and configured to execute the computer-executable instructions to cause the at least one processor to:
facilitate a first virtual test of a first virtual version of the physical product having the first set of parameters, wherein the first virtual test employs a test value of the first metric and results in an output value of a second metric different from the first metric,
facilitate a second virtual test of a second virtual version of the physical product having a second set of parameters, wherein the second virtual test employs the output value of the first metric and results in an additional output value of the second metric, and
compare the output value of the second metric to the additional output value of the second metric to determine whether the physical product having the second set of parameters would be certified according to a standard.

9. The system of claim 8, wherein the testing machine is an AC dielectric test set that performs a dielectric test of a test sample having the first set of parameters, wherein the dielectric test results in a breakdown voltage.

10. The system of claim 9, wherein to facilitate the first virtual test of the first virtual version of the physical product, the at least one processor is configured to:
facilitate a first virtual dielectric test of the first virtual version of the test sample, wherein the first virtual dielectric test results an array of electric field strengths for the first virtual version of the test sample.

11. The system of claim 9, wherein to perform the physical test of the physical product, the testing machine is configured to:
increase a value of the first metric that is applied to the physical product until a test failure event occurs, and
record, as the output value of the first metric, the value of the first metric that was applied to the physical product that caused the test failure event.

12. The system of claim 8, wherein to compare the output value of the second metric to the additional output value of the second metric, the at least one processor is configured to:
determine that the additional output value of the second metric is equal to or greater than the output value of the second metric, and
based on determining that the additional output value is equal to or greater than the output value, determine that the physical product having the second set of parameters should not be certified according to the standard.

13. The system of claim 8, wherein to compare the output value of the second metric to the additional output value of the second metric, the at least one processor is configured to:
determine that the additional output value of the second metric is less than the output value of the second metric, and
based on determining that the additional output value is less than the output value, determine that the physical product having the second set of parameters should be certified according to the standard.

14. The system of claim 8, wherein the test value of the first metric is specified by a standard test associated with the physical product, and wherein the test value of the first metric is less than the output value of the first metric.

15. A non-transitory computer-readable storage medium configured to store instructions executable by one or more processors, the instructions comprising:
instructions for accessing an output value of a first metric resulting from a physical test of a physical product having a first set of parameters, wherein the physical test is performed by a testing machine, and wherein the output value of the first metric corresponds to a test failure of the physical product during the physical test;
instructions for facilitating a first virtual test of a first virtual version of the physical product having the first set of parameters, wherein the first virtual test employs the output value of the first metric and results in an output value of a second metric different from the first metric;
instructions for facilitating a second virtual test of a second virtual version of the physical product having a second set of parameters, wherein the second virtual test employs a test value of the first metric and results in an additional output value of the second metric; and
instructions for comparing the output value of the second metric to the additional output value of the second metric to determine whether the physical product having the second set of parameters would be certified according to a standard.

16. The non-transitory computer-readable storage medium of claim 15, wherein the physical test performed by the testing machine is a dielectric test of a test sample having the first set of parameters, wherein the dielectric test results in a breakdown voltage.

17. The non-transitory computer-readable storage medium of claim 16, wherein the instructions for facilitating the first virtual test of the first virtual version of the physical product comprise:
instructions for facilitating a first virtual dielectric test of the first virtual version of the test sample, wherein the first virtual dielectric test results an array of electric field strengths for the first virtual version of the test sample.

18. The non-transitory computer-readable storage medium of claim 15, wherein the instructions for comparing the output value of the second metric to the additional output value of the second metric comprise:
instructions for determining that the additional output value of the second metric is equal to or greater than the output value of the second metric; and
instructions for, based on determining that the additional output value is equal to or greater than the output value, determining that the physical product having the second set of parameters should not be certified according to the standard.

19. The non-transitory computer-readable storage medium of claim 15, wherein the instructions for comparing the output value of the second metric to the additional output value of the second metric comprise:
instructions for determining that the additional output value of the second metric is less than the output value of the second metric; and
instructions for, based on determining that the additional output value is less than the output value, determining that the physical product having the second set of parameters should be certified according to the standard.

20. The non-transitory computer-readable storage medium of claim 15, wherein the test value of the first metric is specified by a standard test associated with the physical product, and wherein the test value of the first metric is less than the output value of the first metric.
